(19) United States
(12) Patent Application Publication
(10) Pub. No.: US 2022/0053610 A1
(43) Pub. Date: Feb. 17, 2022

(54) Electric Heating Device and Method for Manufacturing the Same

(71) Applicant: Eberspacher catem GmbH & Co. KG, Herxheim (DE)

(72) Inventors: Andreas Klingebiel, Marbach am Neckar (DE); Dietmar Wunstorf, Hildsheim (DE); Karsten Bolz, Kandel (DE); Alfred Blüml, Grünwald (DE)

(21) Appl. No.: 17/400,256

(22) Filed: Aug. 12, 2021

(30) Foreign Application Priority Data
Aug. 13, 2020 (DE) 10 2020 210 284.8

(51) Int. Cl. H05B 3/06; H05B 1/02

(52) U.S. Cl. CPC H05B 3/06; H05B 1/0244; B23K 1/002; H05B 2203/016; H05B 2203/017; H05B 2203/02

(57) ABSTRACT

An electric heating device includes a housing with a partition wall which separates a connection chamber from a heating chamber for emitting heat. At least one heating assembly housing projects from the partition wall in the direction of the heating chamber. The heating assembly housing supports at least one PTC element and strip conductors in an electrically insulated manner A housing wall projecting from the partition wall and delimiting the connection chamber and/or the heating chamber and/or the heating assembly housing is connected to the partition wall by material bonding, which may be by induction soldering. Also disclosed is a method of making an electric heating device.

### BACKGROUND OF THE INVENTION

### 1. Field of the Invention

The present invention relates to an electric heating device with a housing which comprises a partition wall separating a connection chamber from a heating chamber for emitting heat. At least one PTC heating assembly projects from the partition wall in the direction of the heating chamber. This PTC heating element is exposed in the manner of a heating rib in the heating chamber. The PTC heating assembly has at least one PTC element and strip conductors electrically connected thereto, which are assigned different polarities for energizing the PTC element. These strip conductors are electrically connected to the power current in the connection chamber.

### 2. Background of the Invention

Such a heating device is known, for example, from EP 2 337 425 A1. In such an electric heating device, the partition wall is configured in one piece with a heating assembly housing, which projects into the heating chamber as a heating rib. In the aforementioned prior art, the partition wall is manufactured in one piece together with the heating assembly housing by means of aluminum die casting. This type of manufacturing requires a considerable amount of aluminum. The electric heating device is therefore relatively heavy. In the electric heating device mentioned above, a plurality of heating assembly housings are provided which project into the heating chamber as ribs closed at their lower sides. Due to manufacturing requirements, these must be spaced apart from one another by a certain distance, which is contrary to the need for a compact construction.

In the variant according to EP 3 334 242 A1, a PTC heating element is initially produced as a separate component and in this form inserted in a heating element receptacle formed on the partition wall so that the terminal end of the heating element housing is accommodated in a sealed manner in the heating element receptacle of the partition wall and the strip conductors are exposed with their free, terminal ends in the connection chamber where they can be electrically connected. In this prior art, the preassembled PCT heating element is held positively in the heating element receptacle, in which heating element receptacle the PCT heating element is pressed.

This press-fitting receptacle requires a certain wall thickness on the partition wall side. Furthermore, the tightness between the PTC heating element and the heating element receptacle is problematic in this configuration. At the temperatures prevailing in operation, a seal made of a plastic material can age so that there is a risk that the fluid to be heated will leak from the heating chamber into the connection chamber. However, the electrical connection of the PTC element to the power current takes place in the connection chamber so that, with regard to operational safety, no fluid may enter the connection chamber. Otherwise, a short circuit is to be feared. Particularly, when the electric heating device is used in an electrically powered vehicle in which the on-board power supply is also used to operate the electric heating device, such defects give rise to considerable safety concerns.

### SUMMARY

The present invention is based on the problem of providing a compact electric heating device and a method for manufacturing the same.

In order to solve the problem relating to the device, the present invention discloses an electric heating device having a housing with a partition wall which separates a connection chamber from a heating chamber for emitting heat. A housing wall at least partially delimits one of the connection chamber and the heating chamber. At least one heating assembly housing projects into the heating chamber from the partition wall. At least one PTC element and strip conductors ware supported in the heating assembly housing in an insulated manner. The strip connectors are electrically connected to the PTC element and are configured to energize the PTC element with different polarities. At least one of the housing wall and the heating assembly housing is connected to the partition wall in a materially bonded manner, such as by being inductively soldered. The same applies additionally or alternatively to the connection of the heating assembly housing to the partition wall.

In contrast to the prior art discussed first, in which the housing and also the heating rib are manufactured in one piece by aluminum die casting, the present invention allows the subsequent joining of components initially provided from thin sheet metal to define the connection chamber and/or the heating chamber, or the partition wall provided therebetween. The same applies to any connecting ports projecting from a housing wall, for example for fluid lines of a circulation circuit conducting the fluid to be heated in the electric heating device. The electric heating device according to the present invention is, in particular, an electric heating device in a motor vehicle. Flexible hoses are typically connected to and sealed against the respective connecting ports of the electric heating device.

The sheet may have a wall thickness of less than 1 millimeter.

According to the procedure according to the invention, a partition wall is first provided which will separate a connection chamber from a heating chamber on the housing, wherein the partition wall comprises at least one opening for the electrical connection of the PTC element in the connection chamber. Through this opening, the PTC element can be inserted into the heating assembly housing from the side of the connection chamber. The heating device assembly housing is usually closed on the lower side, i.e. with its end lying in the heating chamber. The heating assembly housing may be provided in this manner. The heating assembly housing may be formed by a piece of cylindrical tubular body cut to length, which can be closed on the lower side by deforming the sheet material forming the heating assembly housing. There, the sheet material may be bonded, soldered, welded, and/or closed by beading or a plug inserted in a sealed manner. In the method according to the invention, a housing wall is alternatively or additionally connected to the partition wall by means of induction soldering, wherein this housing wall can completely or partially surround the connection chamber and/or the heating chamber.

The solution according to the invention offers the possibility of a more compact construction of an electric heating device. In contrast to aluminum die castings, the individual heating assembly housings can be provided on the partition wall with a small distance between them. Induction soldering allows locally limited heating so that good dimensional stability of the previously manufactured components of the electric heating device is ensured also after thermal joining. In addition, induction soldering makes it possible to achieve a secure, fluid-tight connection between the partition wall and the component connected to it, for example the heating assembly housing or the housing wall.

The low through heating of the joining partners during induction soldering also allows local heating and thus a relatively compact arrangement of several heating assembly housings connected to the partition wall next to or behind one another. Accordingly, the invention allows greater degrees of freedom in the design of both the heating assembly housing and the housing of the entire electric heating device. Compared to the prior art, the design of the electric heating device according to the invention no longer has to take into account the demolding of an aluminum housing produced by means of die casting.

The procedure during induction soldering allows any arbitrary type of temperature control, as long as it is only below the melting point of the joining partners. These joining partners are usually made of metal, typically a stamped metal sheet, which is usually applied over the entire surface of the partition wall, the heating element housing, and/or the housing wall.

Induction soldering results in a connection over the entire surface and thus a tight connection between the partition wall, the heating element housing and/or the housing wall. Induction soldering can be carried out such that a contact element is applied to the surface of the partition wall, the heating element housing and/or the housing wall, if necessary after a certain amount of preheating to reduce the soldering time. The joint is then heated by induction so that the solder at the joint heats up and liquefies. Capillary forces can draw the solder between the surfaces to be joined and thus concentrate solder at the phase boundary between the two joining partners of the solder joint.

In the method according to the invention, a ring of solder may be arranged adjacent to a gap between the joining partners and formed by the joining partners. An inductor is arranged circumferentially on the outside or inside of the ring, which inductively heats the solder and the joining partners enclosing a gap between them in the area of the gap. As a result, the solder flows into the gap, not least due to capillary action. The inductor is switched on to heat the solder and the surfaces of the joining partners defining the gap. After the solder has melted, the inductor is switched off. The solder flows into the gap and solidifies there.

The joining partners can consist of or contain non-ferrous metals, ferrous metals, chromium-nickel steels and non-metallic materials as well as any combination of these materials.

The soldering method according to the invention results in a corrosion-resistant, in particular gas- and liquid-tight connection between the joining partners. Compared with other material bonds such as gluing or welding, the cycle time of the soldering method is independent of the total length of the joint. Different inductors can be used simultaneously. In this way, soldering can be carried out simultaneously at different points. At the same time, the heating is locally limited. This offers the possibility of equipping the heating assembly housing before soldering. However, equipping after soldering is preferable.

### BRIEF DESCRIPTION OF THE DRAWINGS

Further details and advantages of the present invention become evident from the following description of an embodiment in connection with the drawing, which. Therein:

FIG. 1 shows a perspective view of an embodiment of an electric heating device;

FIG. 2A shows a sectional view with a detail which illustrates the connection between the partition wall and the heating assembly housing;

FIG. 2B shows the detail III according to the illustration in FIG. 2A;

FIG. 3 shows a view according to FIGS. 2A and 2B for a variant before soldering (left) and after soldering (right);

FIG. 4 shows a variant with respect to the illustration according to FIGS. 2A and 2B, wherein the state before soldering is shown on the left and after soldering on the right;

FIG. 5 shows a sectional view of a further variant, wherein the state before soldering is shown on the left and the state after soldering on the right;

FIG. 6 shows a magnified sectional view of a transition region between the partition wall and the heating assembly housing with different variants for applying solder on the left and right;

FIG. 7 shows a sectional view of a housing wall and a part of a connecting port;

FIG. 8 shows a sectional view at the transition between the housing upper part and the housing lower part;

FIG. 9 shows a variant for the illustration according to FIG. 8; and

FIG. 10 shows a variant with respect to the illustration according to FIG. 6.

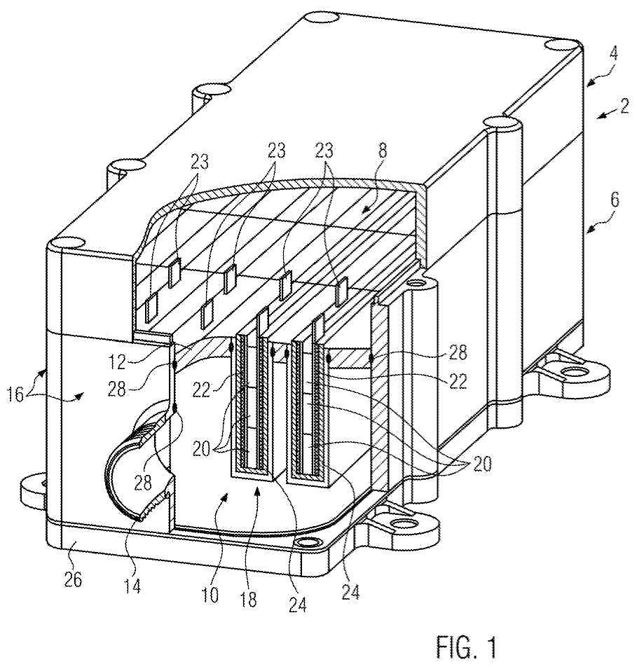

### DETAILED DESCRIPTION

In the Figure, reference sign 2 identifies a housing with a housing upper part 4 and a housing lower part 6. The housing upper part 4 surrounds a connection chamber 8. The housing lower part 6 surrounds a heating chamber 10. A partition wall 12 is located between the heating chamber 10 and the connection chamber 8. The partition wall 12 is fluid-tight so that liquid fluid contained in the heating chamber 10, which is to be heated, cannot reach the connection chamber 8. At the height of the heating chamber 10, the housing 2 is towered above by connecting ports 14, which serve to connect fluid-conducting lines within a motor vehicle. These connecting ports 14 project from opposite housing walls 16, which in the present case surround the heating chamber 6 circumferentially. In the Figure, only one of these connecting ports 14 can be seen, namely partially sectioned.

Reference sign 18 identifies a heating assembly housing, which in the present case is configured as a U-shaped pocket closed on the lower side. In each of these heating assembly housings 18, a plurality of PTC elements 20 are arranged one above the other in the height direction of the heating assembly housing 18 and are arranged between contact surfaces, which as strip conductors 22 are in electrically conductive contact with the respective PTC elements 20 and are formed from a sheet material and form terminal lugs 23, which are electrically conductively connected in the connection chamber. Insulating layers 24 are located on the outside of the respective strip conductor 22 so that heat emitted via main side surfaces of the PTC elements first passes through the strip conductor 22 and then through the insulating layer 24 and is conducted through the walls of the heating assembly housing 18 projecting into the heating chamber 10 as a heating rib.

The heating assembly housing 18 is presently formed from a relatively thin sheet material. The heating assembly housing 18 abuts against an outer surface of the respective insulating layer 24 without a gap there-between. The heating assembly housing 18 can also abut against the respective insulating layer 24 under pretension.

Compared with the prior art EP 2 337 425 A1, the mass of the material forming the heating rib is significantly reduced. Thus, the embodiment shown can be manufactured with less weight. Moreover, a wedge element can be dispensed with, which according to EP 2 337 425 A1 is pressed into the receiving pocket in order to ensure good heat-conducting contact between the PTC element 20 and the surfaces of the heating rib decoupling the heat.

The housing 2 also consists of a relatively thin sheet material. Thus, the heating chamber 10 is circumferentially surrounded by a basically cylindrical sheet metal sleeve which is soldered, in particular induction soldered, to a base plate 26 of the housing 2. The soldered joint is identified by reference sign 28.

The partition wall 12 is also formed from a relatively thin sheet material and is soldered to the inner circumferential surface of the housing 2 in a circumferentially fluid-tight manner. This soldered joint is also identified by reference sign 28.

The heating assembly housing 18 is also soldered to the partition wall 12. For this purpose, the heating assembly housing 18 is inserted into an opening 30 of the partition wall 12 before being equipped with the PTC element(s) 20 and the strip conductors 22 as well as the insulating layers 24, and soldered therein to the partition wall 12.

The connecting port 14 is soldered to the housing wall 16 in the same way. Here, too, the soldering point is identified by reference sign 28.

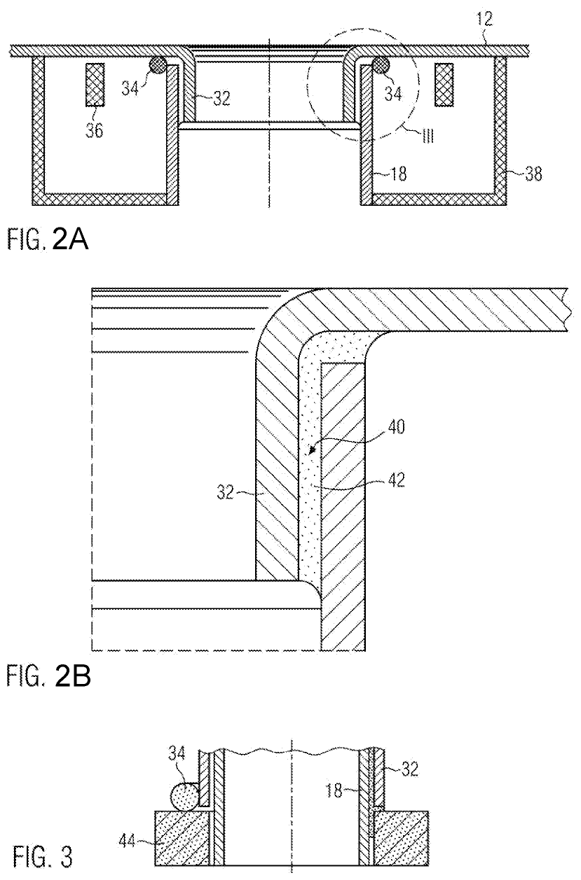

FIG. 2A shows a sectional view of the connection between the partition wall 12 and the heating assembly housing 18. The partition wall 12 is provided with a protruding connecting piece 32 by deep drawing. The connecting piece 32 is integrally formed on the sheet metal part forming the partition wall 12. The connecting piece 32 engages internally in the heating assembly housing 18.

FIG. 2A illustrates with reference sign 34 a ring of solder material, the inner diameter of which is slightly larger than the outer diameter of the heating assembly housing 18. The reference to the diameter does not necessarily mean that the heating assembly housing 18 or the ring 34 are formed circularly in the top view. Rather, the ring 34 may also be formed polygonally, in particular rectangularly.

Reference sign 36 characterizes an inductor. In the embodiment shown, this inductor 36 for soldering is located within a shielding gas housing 38, which essentially abuts sealingly on the one hand against the lower side of the partition wall 12 facing the heating chamber 10 and on the other hand against the outer circumferential surface of the heating assembly housing 18. It goes without saying that soldering is carried out before the base plate 26 is connected to the housing lower part 6.

For soldering, the inductor 36 is switched on, thereby heating the solder as well as the overlapping walls in the area of the connecting piece 32 and the heating assembly housing 18. Solder material here is a high-temperature copper-based solder. During soldering, the shielding gas housing 38 is flooded with shielding gas. As a result of the heating by the inductor 36, the solder melts and, due to capillary action, flows into a gap characterized by reference sign 40 in FIG. 2B. The solder is characterized by reference sign 42 in FIG. 2B. The solidified mold of the solder 42 shown in FIG. 2B is a natural result of the volume of solder 42 used on the one hand and the capillary action on the other.

FIG. 3 shows an alternative embodiment. Reference sign 18 shows the heating assembly housing on the inside; reference sign 32 shows the connecting piece on the outside. The ratios can also be realized inversely, i.e. the connecting piece 32 can be realized with smaller dimensions than the heating assembly housing 18. Only a certain length piece with an overlap is essential. Reference sign 44 characterizes a solder support made of an electrically non-conductive material. Due to this materiality, the solder support 44 is not heated by the inductor 36. The ring 34 rests on a surface of the solder support 44 before soldering. After switching on the inductor 36 (not shown), the solder 42 flows into the gap 40 and solidifies there. This results in a fluid-tight secure connection between the two overlapping sections of the connecting piece 32 on the one hand and the heating assembly housing 18 on the other.

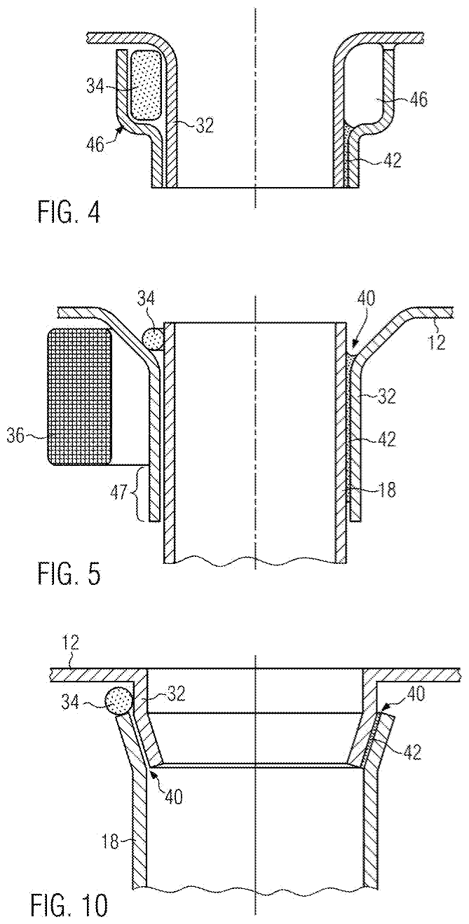

A further variant with respect to the illustration according to FIG. 2A is shown in FIG. 4. There, the solder in the form of the ring 34 is located in a flanged receiving ring 46 before soldering (left). After soldering, the solder has flowed into the gap 40. The receiving ring 46 is emptied. It should be noted that solder has also flowed between the end face of the flanged receiving ring 46 and the outer peripheral surface of the heating assembly housing 18. The variant according to FIG. 4 offers the advantage that the ring 34 can be inserted into the annular gap between the outer and the inner material. The abutting portions substantially seal the accommodation area for the solder 42. This reduces environmental influences during soldering in the area of the soldering point.

FIG. 5 shows another variant in which the heating assembly housing 18 is accommodated within the connecting piece 32, which is integrally formed with the partition wall 12. The overlapping region extends substantially along the height extension of the inductor 36. However, an edge region of the overlapping region characterized by reference sign 47 is shown in the Figure at the bottom, which is not covered by the action of the inductor 36. Accordingly, the opposing joining partners are colder there so that the solder 42 entering in molten form from above inevitably solidifies in this region and prevents the solder 42 from flowing out of the gap 40. The solder 42 cools—as FIG. 5 indicates on the right—at a distance from the lower end of the overlapping region.

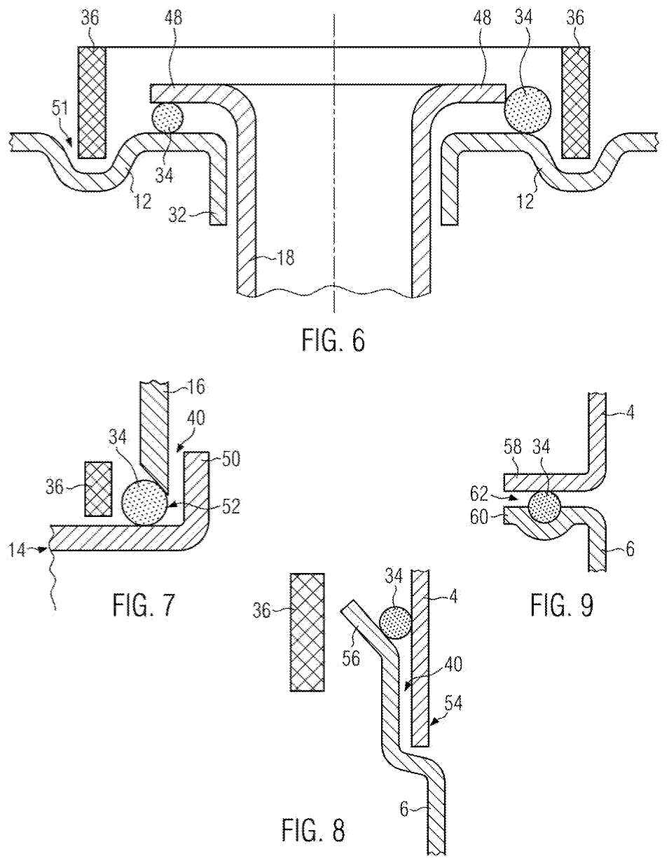

FIG. 6 shows a variant in which the connecting piece 32 is provided on the outside and the heating assembly housing 18 on the inside. The heating assembly housing 18 is provided with a contact flange characterized by reference sign 48. This contact flange 48 is also formed by bending sheet material forming the heating assembly housing 18.

In FIG. 6, the ring 34 is arranged on the left in an annular gap which is bounded in the longitudinal direction of the heating assembly housing 18 by the contact flange 48 on the one hand and the partition wall 12 on the other.

In the variant shown on the right in FIG. 6, the ring 34 is located radially outside the contact flange 48 before soldering. The inductor 36 is configured annularly and surrounds the outer circumference of the contact flange 48. The partition wall 12 is formed radially outside the contact flange 48 in the direction of the heating chamber 10 to create an annular accommodation area 51 for the shaped inductor 36.

FIG. 7 shows a part of the connecting port 14 which is provided with a widened contact flange 50. The housing wall 16 has an outwardly chamfered bore 52. The ring 34 of solder is provided between the material of the housing wall 16 bounding the bore 52 and the connecting port 14. In this embodiment, too, the solder enters the gap 40 between the inner surface of the housing wall 16 and the contact flange 50 as a result of heating by the inductor 36 and due to capillary action.

A variant with respect to FIG. 7 is shown in FIG. 8. In this variant, the housing lower part 6 is bent outwards to form a receptacle 54 which is L-shaped in cross-section. The free end of the housing upper part 4 is inserted in this L-shaped receptacle. The free upper end of the housing lower part 6 is provided with a funnel-shaped bend 56. The ring 34 is clamped therein before soldering. The solder flows into the gap characterized by reference sign 40 when the inductor 36 is activated.

FIG. 9 shows a variant. In this embodiment, the housing upper part 4 and the housing lower part 6 each have opposite flange surfaces 58, 60. The flange surface 60 of the housing lower part 6 is provided with a ring-shaped circumferential recess 62 in which the ring 34 is accommodated.

FIG. 10 shows a further variant for connecting the heating assembly housing 18 to the partition wall 12. Here, too, the partition wall 12 has a connecting piece 32. However, this is formed to taper inwardly at its free end. In a corresponding manner, the heating assembly housing 18 is formed to taper outwardly at its free end. This forming results in a pre-positioning of the components joined in the longitudinal direction of the heating assembly housing 18. The ring 34 is seated between the free end of the heating assembly housing 18 and the partition wall 12 extending thereabove prior to soldering.

1. An electric heating device comprising:
a housing with a partition wall which separates a connection chamber from a heating chamber for emitting heat, wherein a housing wall at least partially delimits one of the connection chamber and the heating chamber, wherein at least one heating assembly housing projects into the heating chamber from the partition wall; and
at least one PTC element and strip conductors which are supported in the heating assembly housing in an insulated manner, the strip connectors being electrically connected to the PTC element and being configured to energize the PTC element with different polarities,
wherein at least one of the housing wall and the heating assembly housing is connected to the partition wall in a materially bonded manner.

2. The electric heating device according to claim 1, wherein at least one of the housing wall and the heating assembly housing is inductively soldered to the partition wall.

3. The electric heating device according to claim 1, wherein the housing wall delimits the connection chamber and the heating chamber.

4. A method for manufacturing an electrical heating device, the electrical heating device comprising a housing, a PTC element, and strip conductors which are electrically connected to the PTC element and which configured to energize the heating element with different polarities, the housing including a partition wall separating a connection chamber from a heating chamber for emitting heat, wherein a housing wall at least partially delimits one of the connection chamber and the heating chamber (10), wherein at least one heating assembly housing projects from the partition wall into the heating chamber, and wherein the PTC element and the strip conductors are electrically connected in the connection chamber and are supported in an insulated manner in the heating assembly housing, the method comprising:
providing the partition wall with an opening for the electrical connection of the PTC element in the connection chamber, and then
soldering the housing wall or the heating assembly housing to the partition wall.

5. The method according to claim 4, wherein the housing wall or the heating assembly housing is inductively soldered to the partition wall.

6. The method according to claim 4, wherein the housing wall and the heating assembly housing are inductively soldered to the partition wall.

7. The method according to claim 4, wherein, after soldering, the PTC element and the strip conductors are inserted into the heating assembly housing, and the strip conductors are electrically connected in the connection chamber.

8. The method according to claim 4, wherein, during soldering, a ring of solder is arranged adjacent to a gap between the partition wall and the housing wall or the heating assembly housing and is inductively melted so that the solder flows into the gap and solidifies there.
